(19) United States
(12) Patent Application Publication
(10) Pub. No.: US 2011/0072482 A1
(43) Pub. Date: Mar. 24, 2011

(54) Entertainment Control System and Related Methods

(75) Inventor: Jimmy K. Lau, Temple City, CA (US)

(73) Assignee: BELKIN INTERNATIONAL, INC., Playa Vista, CA (US)

(21) Appl. No.: 12/861,831

(22) Filed: Aug. 24, 2010

Related U.S. Application Data
(63) Continuation of application No. PCT/US2010/046396, filed on Aug. 23, 2010.
(60) Provisional application No. 61/235,991, filed on Aug. 21, 2009.
(60) Provisional application No. 61/376,242, filed on Aug. 23, 2010.

(51) Int. Cl. H04N 7/173

(52) U.S. Cl. 725/116

(57) ABSTRACT

In some examples, a control system comprises a first unit and a second unit. The first unit comprises a command input configured to receive one or more commands from one or more command devices of a command device array, and a first transceiver configured to transmit one or more encoded commands. The second unit second unit comprises a second transceiver configured to receive the one or more encoded commands from the first transceiver, and a command output configured to output one or more decoded commands to a content source array. The first and second units are separate from each other. The one or more encoded commands correspond to the one or more commands, the one or more decoded commands correspond to the one or more encoded commands, and the content source array comprises one or more content sources. Other examples and related methods are described herein.

### CROSS-REFERENCE TO RELATED APPLICATIONS

This patent application is a continuation of:
International Patent Application PCT/US2010/046396, titled Entertainment Control System and Related Methods, filed on Aug. 23, 2010;

which claims priority to:
U.S. Provisional Patent Application No. 61/235,991 titled Wireless Entertainment System Controller, and filed on Aug. 21, 2009; and
U.S. Provisional Patent Application No. 61/376,242, titled Wireless Entertainment System Controller, and filed on Aug. 23, 2010.

The disclosures of the referenced applications are incorporated herein by reference.

### TECHNICAL FIELD

This disclosure relates generally to entertainment systems, and relates more particularly to entertainment control systems and related methods.

### BACKGROUND

With the ever increasing availability of audiovisual devices for home entertainment systems, many users have distributed such audiovisual devices throughout different rooms in their homes. Users are still usually restricted, however, to a main entertainment system location where content sources are located if they want to access and control content therefrom.

Accordingly, a need exists for entertainment control systems and related methods that allow users to control content sources located in locations different than the location where the users are watching an the content.

### BRIEF DESCRIPTION OF THE DRAWINGS

The invention will be better understood from a reading of the following detailed description of examples of embodiments, taken in conjunction with the accompanying figures.

FIG. 1 presents a block diagram of an embodiment of an exemplary system for wirelessly controlling an entertainment system.

FIG. 2 presents a block diagram of an exemplary transmitter unit of the system of FIG. 1.

FIG. 3 presents a block diagram of an exemplary receiver unit of the system of FIG. 1.

FIG. 4 presents a flowchart of a method for providing a control system, such as for the entertainment system of FIG. 1.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, mechanically or otherwise. Two or more mechanical elements may be mechanically coupled, but not otherwise coupled. Coupling (whether mechanical or otherwise) may be for any length of time, e.g., permanent or semi-permanent or only for an instant. “Mechanical coupling” and the like should be broadly understood and include mechanical coupling of all types. The absence of the word “removably,” “removable,” and the like near the word “coupled,” and the like does not mean that the coupling, etc. in question is or is not removable.

### DESCRIPTION

In one embodiment, a control system comprises a first unit and a second unit. The first unit comprises a command input configured to receive one or more commands from one or more command devices of a command device array, and a first transceiver configured to transmit one or more encoded commands. The second unit second unit comprises a second transceiver configured to receive the one or more encoded commands from the first transceiver, and a command output configured to output one or more decoded commands to a content source array. The first and second units are separate from each other. The one or more encoded commands correspond to the one or more commands, the one or more decoded commands correspond to the one or more encoded commands, and the content source array comprises one or more content sources.

In one embodiment, a control system comprises first and second units. The first unit comprises a command input configured to receive one or more original commands from one or more command devices, a first processing module coupled to the command input and comprising at least one of: a first signal processor to encode the one or more original commands into one or more encoded commands, or a first microcontroller to packetize the one or more encoded commands for RF transmission, a first transceiver coupled to the first processing module to: transmit the one or more encoded commands via RF command signals, and receive a content stream via RF content signals, and a content output coupled between the first transceiver and a monitor to feed the content stream derived from the RF content signals to the monitor. The second unit comprises one or more content source inputs configured to be coupled to one or more content sources and to receive the content stream from the one or more content sources, a second transceiver configured to: receive the one or more encoded commands via the RF signals from the first transceiver, and transmit the content stream to the first transceiver via the RF content signals, a second processing module coupled to the second transceiver and comprising at least one of: a second microcontroller to de-packetize the one or more encoded commands packetized by the first microcontroller, or a second signal processor to decode the one or more encoded commands into one or more decoded commands that mimic the one or more original commands received by the command input of the first unit, and a command output coupled to the second processing module to output the one or more decoded commands to the one or more content sources. The first and second units are separate from each other.

In one embodiment, a method for providing a control system comprises providing a first unit to (a) receive one or more original commands from one or more command device, (b) encode the one or more original commands into one or more encoded commands, and (c) transmit the one or more encoded commands. The method also comprises providing a second unit to (a) receive the one or more encoded commands from the first unit, (b) reconstruct the one or more original commands as one or more decoded commands based on the one or more encoded commands, and (c) control with the one or more decoded commands one or more content sources coupled to the second unit. The first and second units are separate from each other.

Other examples and embodiments are further disclosed herein. Such examples and embodiments may be found in the figures, in the claims, and/or in the description of the present application.

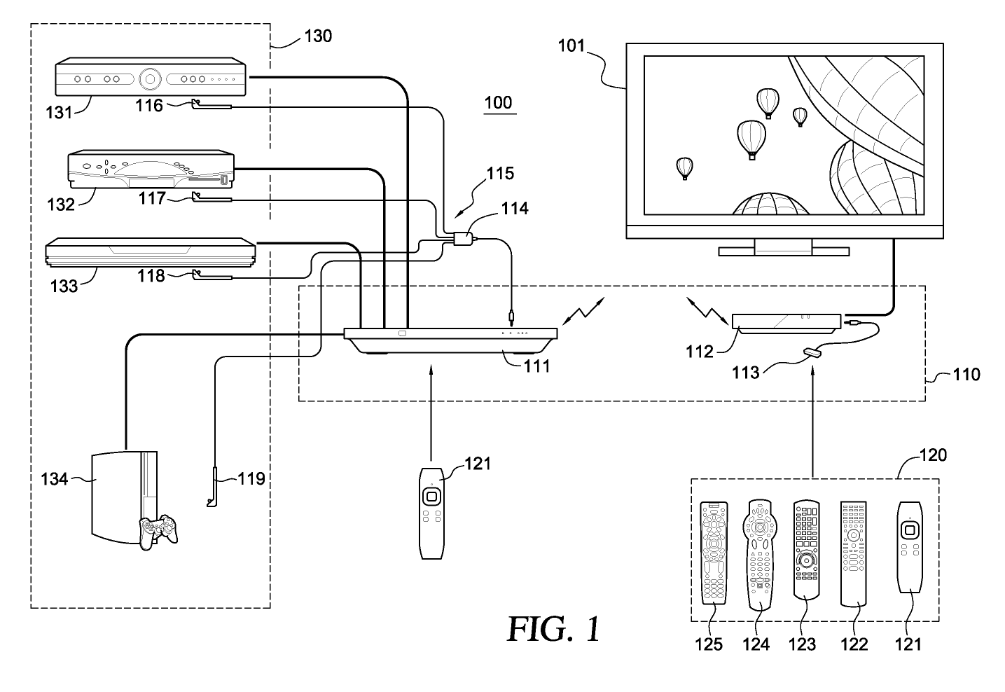

FIG. 1 is a block diagram of an embodiment of an exemplary system for wirelessly controlling an entertainment system. FIG. 1 includes entertainment system 100, comprising monitor 101, wireless content delivery system 110, wireless command device array 120, and content source array 130. In some examples, content delivery system 110 may be referred to as a control system. Entertainment system 100 is merely exemplary and is not limited to the embodiments presented herein. Wireless content delivery system 110 is coupled to and in electronic communication with monitor 101. Wireless content delivery system 110 is coupled also to and in electronic communication with content source array 130. Additionally, wireless content delivery system 110 is in wireless communication with wireless command device array 120. In operation, wireless entertainment system 100 is configured to transmit high definition video over household distances with little to no perceptible loss of video quality.

Wireless content delivery system 110 includes a wireless transmitter device unit 111 and a wireless receiver device 112. In the present example, wireless receiver dongle 113 is coupled to and in electrical communication with wireless receiver device 112, although there can be also examples where wireless receiver dongle 113 is integrated within receiver device 112. The present example also comprises wireless blaster dongle assembly 115, comprising wireless blaster units 116-119 and blaster cable splitter 114 coupled to and in electrical communication with transmitter device 111 and each associated wireless blaster unit(s) 116-119, but there can be examples where blaster dongle assembly 115 may be integrated as part of transmitter device 111.

Wireless command device array 120 includes one or more wireless command devices 121-125 (e.g., remote control devices associated with the content sources of content source array 130). In the present example, wireless command device 121 is specifically associated with wireless transmitter device 111 and wireless receiver device 112, and each of wireless command devices 122-125 are paired or affiliated with an associated or different one of the content sources (see below) within content source array 130. Examples of devices that may function as wireless command devices 122-125 include an RMT-V501A video/DVD combo IR remote available from Sony Corporation of Japan, RM-Y 199 TV remote also available from Sony Corporation of Japan, a standard cable IR remote available from a cable provider, such as, from Time Warner Cable of New York, N.Y., a standard satellite IR remote, such as from DIRECTV Group of El Segundo, Calif., and the like. Content source array 130 does not include wireless blaster units 116-119.

Content source array 130 includes one or more content sources in the present example, like satellite TV receiver set-top box 131, such as one provided by DIRECTV Group of El Segundo, Calif., a cable TV set-top box 132, such as one provided by Time Warner Cable of New York, N.Y., a DVD player 133, such as an SLV-300D available from Sony Corporation of Japan, a video game console 134, such as a PlayStation®3 available from Sony Corporation of Japan, and the like.

In the present embodiment, wireless content delivery system 110 of wireless entertainment system 100 is implemented to comprise wireless video transmitter (TX unit) 111, wireless receiver unit 112, wireless receiver dongle 113, and wireless blaster dongle assembly 115. In the present example, wireless receiver dongle 113 is configured to receive commands from wireless command device array 120 via infrared (IR) input signals, while wireless blaster dongle assembly 115 is configured to send IR output signals to the content sources of content source array 130. There can be other embodiments, however, where receiver unit 112 may communicate with wireless command array via non-infrafed signals, such as via radio frequency (RF) signals. Similarly, there can be embodiments where transmitter device 111 may communicate with content source array via non-infrared signals, like RF signals.

In the present embodiment, video & audio signals from content sources 131-134 in content source array 130 can be selected at transmitter unit 111 and sent via RF or other wireless signals to receiver unit 112. At receiver 112, the received video/audio signals are then passed via a video and/or audio connector and displayed on monitor 101. In the present example, the video and/or audio connector can comprise a high-definition multimedia interface (HDMI) connector, a digital visual interface (DVI) connector, a component video connector, a coaxial video connector, and the like. Monitor 101 can comprise a television, such as a high definition television (HDTV). Further to the embodiment, a user may operate an IR remote control, such as wireless command device 121 of wireless command device array 120, which is associated with transmitter unit 111, to instruct transmitter unit 111 to select one of the content sources 131-134 for sourcing video and/or audio content to monitor 101 via transmitter unit 111 and receiver unit 112.

In the present embodiment, a user may operate a remote control, such as wireless command device 121 of wireless command device array 120, which is affiliated with transmitter unit 111 and receiver unit 112, to instruct transmitter unit 111 to select a desired one of content sources 131-134 of content source array 130 for sourcing content for monitor 101. Receiver unit 112 then converts the user's instructions within the received IR signal to RF or other wireless signals and passes the converted instructions to transmitter unit 111. In the same or other embodiments, a user may operate one or more remote controls, such as wireless command devices 122-125 of wireless command device array 120, which are affiliated with video/audio equipment of content source array 130, to control a functionality of one or more of content sources 131-134 of content source array 130 via receiver nit 112. Receiver unit 112 then converts the user's instructions within the received IR signal to an RF signal and passes the converted instructions via the RF signal to transmitter unit 111, which processes the received instruction. Transmitter unit 111 passes the processed instruction via a wire to wireless IR blaster dongle assembly 115, which passes the processed instruction to wireless floater units 116-119 via another wire, and wireless blaster units 116-119 blasts or transmits the processed instruction via an IR signal to be received by video/audio equipment of content source array 130.

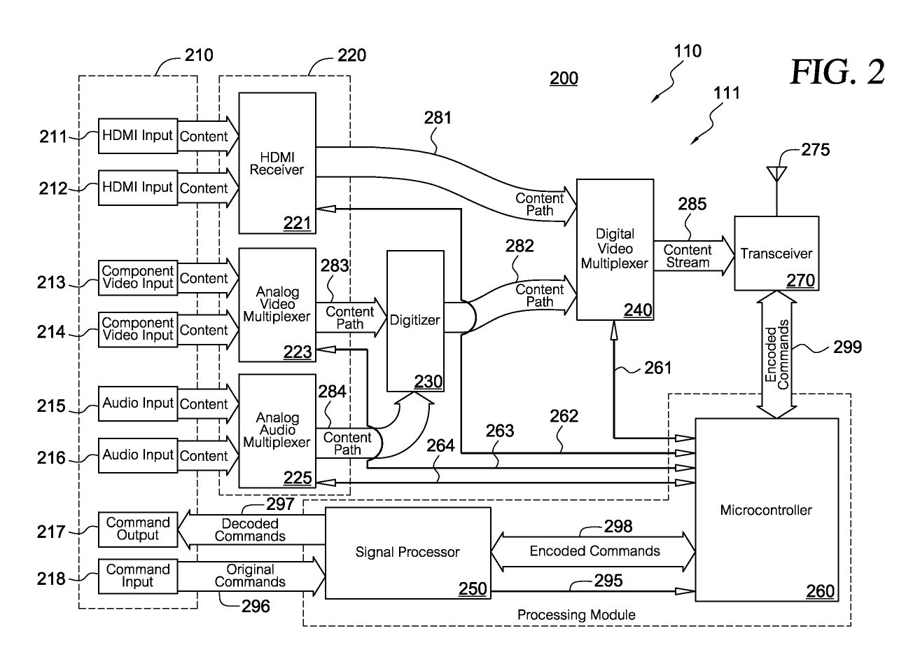

FIG. 2 is a block diagram 200 of an embodiment of exemplary wireless transmitter unit 111 of FIG. 1. FIG. 2 illustrates the internal architecture of transmitter unit 111. Transmitter unit 111 in FIG. 2 is merely exemplary and is not limited to the embodiments presented herein. In FIG. 2, transmitter unit 111 includes content source input array 210, input processing array 220, video/audio digitizer circuit 230, digital video multiplexer circuit 240, signal processor 250, microcontroller 260, and transceiver 270 that includes antenna 275. In the present example, signal processor 250 is configured to process IR commands or signals, and transceiver 270 is configured to transmit and receive RF signals.

In FIG. 2, content source input array 210 is coupled to and in communication with input processing array 220 and signal processor 250. Input processing array 220 is coupled to and in communication with video/audio digitizer circuit 230 and digital video multiplexer circuit 240. Video/audio digitizer circuit 230 is coupled to and in communication with digital video multiplexer circuit 240. Signal processor 250 is coupled to and in communication with microcontroller 260. Digital video multiplexer circuit 240 is coupled to and in communication with transceiver 270. Microcontroller 260 is coupled to and in communication with transceiver 270. Microcontroller 260 additionally is coupled to and provides control signals 261-264 to components (detailed below) of input processing array 220 and digital video multiplexer circuit 240.

In FIG. 2, content source input array 210 includes HDMI input 211, HDMI input 212, component video input 213, component video input 214, audio input 215, audio input 216, command output 217 and command input 218. In some examples, command output 217 can be coupled to a blaster dongle assembly 115 and or blaster units 116-119. Input processing array 220 includes HDMI receiver 221, analog video multiplexer 223 and analog audio multiplexer 225. HDMI receiver 221 includes an input and an output. The input of HDMI receiver 221 is coupled to and in electrical communication with HDMI input 211 and HDMI input 212 of content source input array 210. The output of HDMI receiver 221 is coupled to and in electrical communication with digital video multiplexer circuit 240. Analog video multiplexer 223 includes an input and an output. The input of analog video multiplexer 223 is coupled to and in electrical communication with component video input 213 and component video input 214 of content source input array 210. The output of analog video multiplexer 223 is coupled to and in electrical communication with video/audio digitizer circuit 230. Analog audio multiplexer 225 includes an input and an output. The input of analog audio multiplexer 225 is coupled to and in electrical communication with audio input 215 and audio input 216. The output of analog audio multiplexer 225 is coupled to and in electrical communication with video/audio digitizer circuit 230. Signal processor 250 includes an input in electrical communication with and coupled to command input 218 and an output in electrical communication with and coupled to command output 217 of content source input array 210.

In some embodiments, transmitter unit 111 functions as follows: desired video & audio content from content source input array 210 is selected using the corresponding multiplexer circuits (components of input processing array 220 and/or digital video multiplexer 240) controlled by microcontroller 260 to enable corresponding ones of content paths 281-284 via control signals 261-26 based on user provided input received by microcontroller 260 via command input 218. The selected content stream 285 is then transmitted via transceiver 270. In other embodiments, encoded commands 299 can be received by transceiver 270, such as via RF signals from receiver unit 112 of FIG. 1. Encoded commands 299 can be sent to microcontroller 260 for further processing. For example, encoded commands 299 can be de-packetized from their RF transmission form by microcontroller 260, and can be forwarded as encoded commands 298 to signal processor 250. Transmitter device 111 can then process encoded commands 298 and/or 299 depending on the type of command.

In one example, encoded commands 299 may comprise a functionality command to control a functionality of a content source coupled to an input of content source input array 210. Encoded commands 299 can be an encoded version of original functionality commands that were sent to receiver unit 112 (FIG. 1) by one of the wireless command devices of wireless command array 120, where receiver unit 112 encoded the original functionality commands and forwarded them to transceiver 270. In such examples, the original functionality commands may be regenerated into decoded functionality commands by signal processor 250, where the decoded functionality commands are configured to mimic the original functionality commands. The decoded functionality commands can be sent by signal processor 250 to command output 217 as part of decoded commands 297. In the example of FIGS. 1-2, blaster dongle assembly 115 can be coupled to command output 217, and the decoded functionality commands can be sent to one of more of content sources 131-134 of content source array 130 via blaster units 116-119 of blaster dongle assembly 115. In some examples, the decoded functionality commands can be used to control functionalities of the content sources of content source array 130, such as volume, record, play, pause and/or channel changing functionalities, among others.

In the same or other examples, encoded commands 299 may comprise a select command to select one or more of content source inputs 211-216 for sourcing content to receiver unit 112 via content stream 285 and transceiver 270. In such examples, the select command in encoded commands 299 may be an encoded version of an original select command that was sent to receiver unit 112 (FIG. 1) by wireless command array 120, such as from wireless command device 121, which is affiliated with transmitter unit 111 and receiver unit 112. When the select command is received as part of encoded commands 299, microcontroller 260 may execute the select command to enable or disable one or more of content paths 281-284 via one or more of control signals 261-264 such that content from the desired content source input of content source input array 210 may reach content stream 285 for transmission via transceiver 270. In some embodiments, microcontroller 260 may execute the select command once the select command has been decoded by signal processor 250, upon receipt of input selection signal 295 from signal processor 250.

In the same or other embodiments, signal processor 250 may receive commands via command input 218 from an affiliated remote control, such as wireless command device 121 (FIG. 1). If the command received at command input 218 comprises a select command, it can be sent to signal processor 250 as part of original commands 296 so that signal processor can determine which of the content source inputs of content source input array 210 should be routed to content stream 285, as described above.

In the present example, the commands received by transmitter unit 111, such as original commands 296 or encoded commands 299, can comprise an ID code that identifies the command as originating from a wireless command device affiliated with transmitter unit 111 and receiver unit 112, such as wireless command device 121. When the commands are received by signal processor 250, signal processor 250 may determine whether the commands came from the wireless command device affiliated with transmitter unit 111, such as by comparing the ID code of the command against a look-up table that may be comprised by signal processor 250. In some examples, if the command comprises a select command, and signal processor 250 recognizes the ID code of the command as originating from an affiliated wireless command device, signal processor 250 can generate input selection signal 295 and pass it to microcontroller 260 for implementation, as described previously. In the same or other examples, if the ID code contained within the command does not match any values within the look-up table, thus signifying that the command is received from a non-affiliated wireless command device, such as one of command devices 122-125, no signal need be sent to microcontroller 260.

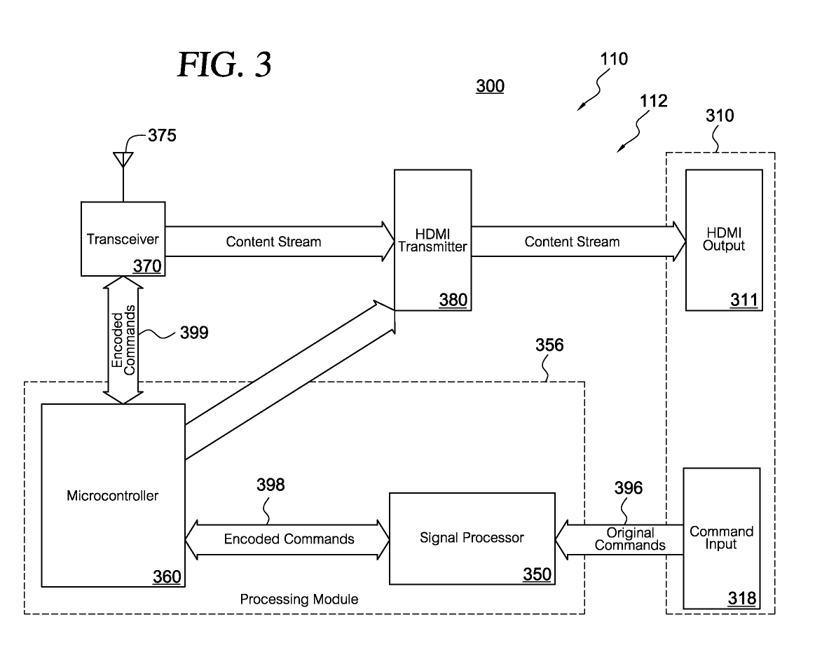

FIG. 3 is a block diagram 300 of an embodiment of exemplary receiver device unit 112 of FIG. 1. FIG. 3 illustrates the internal architecture of receiver unit 112. Receiver unit 112 in FIG. 3 is merely exemplary and is not limited to the embodiments presented herein. In FIG. 3, receiver unit 112 includes interface array 310 that includes HDMI output connector 311 and command input 318, processing module 356 comprising signal processor 350, and microcontroller 360, transceiver 370, antenna 375, and HDMI transmitter 380. In some examples, signal processor 350 can be similar to signal processor 250 (FIG. 2), command input 318 can be similar to command input 218 (FIG. 2), microcontroller 360 can be similar to microcontroller 260 (FIG. 2), transceiver 370 can be similar to transceiver 270 (FIG. 2), and/or antenna 375 can be similar to antenna 275 (FIG. 2).

In FIG. 3, interface array 310 is coupled to and in communication with signal processor 350 and HDMI transmitter 380. Signal processor 350 is additionally coupled to and in communication with microcontroller 360. Microcontroller 360 is additionally coupled to and in communication with transceiver 370 and HDMI transmitter 380. Transceiver 370 is additionally coupled to and in communication with HDMI transmitter 380. Signal processor 350 includes an input coupled to and in communication with command input 318 of interface array 310. HDMI transmitter 380 includes an output coupled to and in communication with HDMI output 311. Although the present example is configured to provide HDMI output 311, in the same or other examples other kinds of digital outputs, such as a DVI output, or analog outputs, such as a component video output, can be provided for audio, visual, or audiovisual devices such as monitor 101 (FIG. 1).

In some embodiments, receiver unit 112 functions as follows: content signals received at transceiver 370 are sent to HDMI transmitter 380 where they are translated to Transition Minimized Differential Signaling (TMDS) signals for sending out via HDMI output 311 for display on monitor 101 of FIG. 1. In the same or other embodiments, command input 318 can receive an original command, such as via IR signals, from one of wireless command devices 121-125 of wireless command device array 120 of FIG. 1.

Command input 318 passes the received original command to signal processor 350. In some examples, signal processor 350 may determine whether the original command originated from a wireless command device affiliated with wireless content delivery system 110, like wireless command device 121. Signal processor 350 may accomplish this by comparing the ID code of the original command to a look-up table, for example, contained within signal processor 350, and generating an input selection command signal from the look-up table when there is a match. This input selection command signal may then be passed to microcontroller 360, which produces an input source selection special packet based on the command signal and passes the input source selection special packet to RF transceiver 370 for transmission to transmitter unit 111.

In the same or other examples, when original command 396 is received and encoded by signal processor 350, into encoded command 398. There can be examples where encoded command 398 is then packetized by microcontroller 360 into encoded commands 399 for transmission in RF form via transceiver 370. Transceiver 360 can then transmit encoded commands 399 to transceiver 270 for receipt as encoded commands 299 (FIG. 2) and for processing as described above with respect to FIG. 2.

In some examples, signal processor 350 may encode original commands 396 into encoded commands 398 via an algorithm of signal processor 350. Similarly, signal processor 250 (FIG. 2) may decode encoded commands 298 to generate decoded commands 297 and/or input selection signal 295 via a corresponding algorithm of signal processor 250 (FIG. 2).

There can be examples where the algorithm for signal processor 350 may comprise extracting a command carrier frequency and a command envelope from original command 396. There can be examples where the command carrier frequency can be stored in a frequency register of signal processor 350 once extracted from original command 396. The frequency register may contain a single word representing the command carrier frequency of original command 396. In some examples, the command carrier frequency may be of approximately 20 kilohertz (KHz) to approximately 70 KHz. In the same or other examples, the command carrier frequency may list the number of system clocks for each cycle the carrier signal of original command 396.

In the same or other examples, the command envelope of original command 396 may be stored in an envelope register of signal processor 350. The envelope register may contain a variable FIFO stack of, for example, 128 words, representing the envelope of original command 396. Each word may represent the duration of a state (high or low) after each transition of the envelope. The command or order encompassed by original command 396 is stored in the command envelope.

Once the command carrier frequency and the command envelope for original command 396 have been encoded as described above, they can be sent as part of encoded commands 399 via transceiver 370 to be received as encoded commands 299 by transceiver 270 of transmitter unit 111 (FIGS. 1-2). Signal processor 250 would then receive the command carrier frequency and the command envelope from encoded command 298, and would store them in its respective frequency and envelope registers. In some examples, the contents of the frequency and envelop registers may be logically ANDED together to combine the clock and envelope to generate decoded commands 297 that can be sent via command output 217 to content source array 130 (FIGS. 1-2).

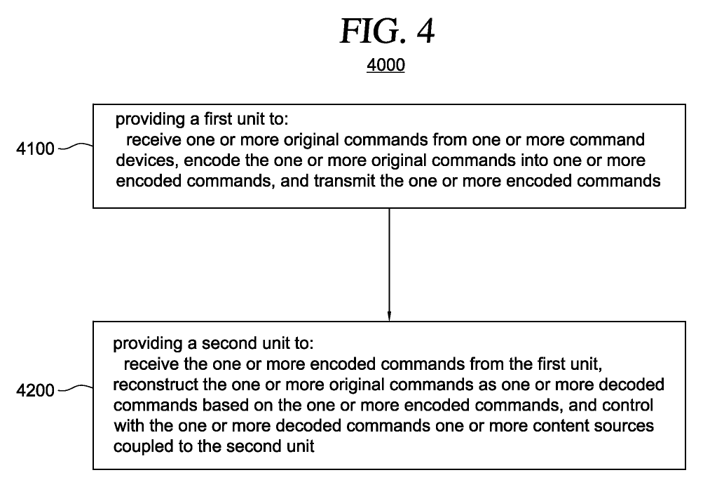

Continuing with the figures, FIG. 4 illustrates a flowchart of method 4000 for providing a control system such as for an entertainment system. In some examples, the control system of method 4000 can be similar to content delivery system 110 (FIGS. 1-3), as described above. In the same or other examples, the control system of method 4000 can be coupled to a content source array similar to content source array 130 (FIG. 1), and/or to audiovisual devices like monitor 101 (FIG. 1). In the same or other examples, the control system of method 4000 can be configured to respond to commands from one or more wireless command devices, such as wireless command devices 121-125 (FIG. 1).

Block 4100 of method 4000 comprises providing a first unit to (a) receive one or more original commands from one or more command devices, (b) encode the one or more original commands into one or more encoded commands, and (c) transmit the one or more encoded commands. In some examples, the first unit can be similar to receiver unit 112 (FIGS. 1, 3), the one or more original commands may be similar to original commands 396 (FIG. 3), and the one or more encoded commands may be similar to one or more of encoded commands 398-399 (FIG. 3).

Block 4100 of method 4000 comprises providing a first unit to (a) receive one or more original commands from one or more command devices, (b) encode the one or more original commands into one or more encoded commands, and (c) transmit the one or more encoded commands. In some examples, the first unit can be similar to receiver unit 112 (FIGS. 1, 3), the one or more original commands may be similar to original commands 396 (FIG. 3), and the one or more encoded commands may be similar to one or more of encoded commands 398-399 (FIG. 3).

Block 4200 of method 4000 comprises providing a second unit to (a) receive the one or more encoded commands from the first unit, (b) reconstruct the one or more original commands as one or more decoded commands based on the one or more encoded commands, and (c) control with the one or more decoded commands one or more content sources coupled to the second unit. In some examples, the second unit can be similar to transmitter unit 111 (FIGS. 1-2), the one or more encoded commands can be similar to one or more of encoded commands 298-299 (FIG. 2), the one or more decoded commands can be similar to decoded commands 297 (FIG. 2), and the one or more content sources can be similar to content sources of content source array 130 (FIG. 1).

In some examples, the second unit of method 4000 may be also provided to (a) receive a content stream from the one or more content sources, (b) encode the content stream into an encoded content stream, and (c) transmit the encoded content stream to the first unit. In such examples, the first unit of method 4000 may also be provided to (a) decode the encoded content stream into a decoded content stream, and (b) provide the decoded content stream to a monitor coupled to the first unit. There can be examples where the content stream may be similar to content stream 285 (FIG. 2), as received from content source input array 210, and the encoded content stream may comprise content stream 285 as encoded and/or transmitted by digital video multiplexer or transceiver 270 (FIG. 2). In the same or other examples, the encoded content stream may be received by the first unit, and may be decoded by transceiver 370 and/or HDMI transmitter 380 to be provided to the monitor via HDMI output 311 (FIG. 3).

In some examples, some of the blocks of method 4000 can be subdivided into one or more sub-steps. In the same or other examples, one or more of the different blocks of method 4000 can be combined into a single block or performed simultaneously, and/or the sequence of such steps can be changed. For example, block 4100 may be carried out after block 4200. There can also be examples where method 4000 can comprise further or different steps. Other variations can be implemented for method 4000 without departing from the scope of the present disclosure.

Although the entertainment control system and related methods herein have been described with reference to specific embodiments, various changes may be made without departing from the spirit or scope of the present disclosure. Examples of such options and other embodiments have been given in the foregoing description. Accordingly, the description is intended to be illustrative of the scope of the present disclosure and is not intended to be limiting. Other permutations of the different embodiments having one or more of the features of the various figures are likewise contemplated. It is intended that the scope described herein shall be limited only to the extent required by the appended claims.

The entertainment control system and related methods discussed herein may be implemented in a variety of embodiments, and the foregoing discussion of these embodiments does not necessarily represent a complete description of all possible embodiments. Rather, the detailed description of the drawings, and the drawings themselves, disclose at least one preferred embodiment, and may disclose additional embodiments.

All elements claimed in any particular claim are essential to the entertainment control system and related methods claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefit, advantage, solution, or element is stated in such claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A control system comprising:
a first unit comprising:
a command input configured to receive one or more commands from one or more command devices of a command device array; and
a first transceiver configured to transmit one or more encoded commands;
and
a second unit comprising:
a second transceiver configured to receive the one or more encoded commands from the first transceiver; and
a command output configured to output one or more decoded commands to a content source array;
wherein:
the first and second units are separate from each other;
the one or more encoded commands correspond to the one or more commands;
the one or more decoded commands correspond to the one or more encoded commands; and
the content source array comprises one or more content sources.

2. The control system of claim 1, wherein:
the one or more commands comprise a functionality command from a first command device of the command device array,
the first command device being affiliated with a first content source of the content source array,
the first content source comprising a functionality controllable by the functionality command;
the first unit is configured to transmit an encoded functionality command of the one or more encoded commands to the second unit, the encoded functionality command being derived from the functionality command; and
the second unit is configured to output a decoded functionality command of the one or more decoded commands to the first content source to control the functionality of the first content source, the decoded functionality command being derived from the encoded functionality command.

3. The control system of claim 1, wherein:
the one or more commands comprise a select command from a select command device of the command device array, the select command device being affiliated with the first and second units and comprising a selection order to select a first content source of the content source array;
the first unit is configured to transmit an encoded select command of the one or more encoded commands to the second unit, the encoded select command being derived from the select command; and
the second unit is configured to:
decode the encoded select command; and
select the first content source to source content via the second transceiver to the first unit in response to the encoded select command.

4. The control system of claim 1, wherein:
the first unit comprises:
a first signal processor coupled between the command input and the first transceiver;
wherein:
the command input is configured to forward the one or more commands to the first signal processor; and
the first signal processor is configured to:
encode the one or more commands into the one or more encoded commands; and
forward the one or more encoded commands to the first transceiver.

5. The control system of claim 4, wherein:
the first unit comprises:
a first microcontroller coupled between the first transceiver and the first signal processor; and
the first microcontroller is configured to:
receive the one or more encoded commands from the first signal processor; and
packetize the one or more encoded commands for transmission in packetized form via the first transceiver.

6. The control system of claim 4, wherein:
the command input is configured to receive a functionality command of the one or more commands from a functionality command device of the one or more command devices;
the functionality command comprises:
a functionality order for a first content source of the one or more content sources;
a command carrier frequency; and
a command envelope comprising the functionality order;
the first signal processor is configured to:
derive and encode the command carrier frequency as part of an encoded functionality command of the one or more encoded commands;
derive and encode the command envelope as part of the encoded functionality command;
and
the first transceiver is configured to transmit the encoded functionality command to the second transceiver.

7. The control system of claim 4, further comprising:
a select command device of the one or more command devices;
wherein:
the select command device is affiliated with the first and second units;
the command input is configured to receive a select command of the one or more commands from the select command device;
the select command comprises:
an ID code to identify the select command device;
a selection order for the second unit to select a first content source of the one or more content sources for transmission of content to the first unit via the second unit;
a command carrier frequency; and
a command envelope comprising the ID code and the selection order;
the first signal processor is configured to:
derive and encode the command carrier frequency as part of an encoded select command of the one or more encoded commands; and
derive and encode the command envelope as part of the encoded select command; and
the first transceiver is configured to transmit the encoded select command to the second transceiver.

8. The control system of claim 1, wherein:
the second unit comprises:
a second signal processor coupled between the command output and the second transceiver;
wherein the second signal processor is configured to:
decode the one or more encoded commands into the one or more decoded commands; and
forward the one or more decoded commands to the command output.

9. The control system of claim 8, wherein:
the second unit comprises:
a second microcontroller coupled between the second transceiver and the second signal processor; and
the second microcontroller is configured to:
receive the one or more encoded commands from the second transceiver; and
de-packetize the one or more encoded commands for the second signal processor.

10. The control system of claim 8, wherein:
the second signal processor comprises:
a first register configured to store an encoded command carrier frequency of a first encoded command of the one or more encoded commands; and
a second register configured to store an encoded command envelope of the first encoded command;
and
the second signal processor is configured to:
combine the encoded command carrier frequency and the encoded command envelope to generate a first decoded command of the one or more decoded commands.

11. The control system of claim 8, wherein:
the one or more encoded commands received by the second transceiver from the first transceiver comprise:
an encoded functionality command comprising a functionality order to control a functionality of a first content source of the one or more content sources;
the second signal processor is configured to:
garner a command carrier frequency from the encoded functionality command;
garner a command envelope from the encoded functionality command, the command envelope comprising the functionality order; and
combine the command carrier frequency and the command envelope to generate a decoded functionality command of the one or more decoded commands corresponding to the encoded functionality command;
the decoded functionality command corresponds to a functionality command of the one or more commands received by the command input of the first unit;
and
the command output is configured to transmit the decoded functionality command to the first content source.

12. The control system of claim 11, wherein:
the command output of the second unit is coupled to one or more blaster units; and
the one or more blaster units comprise one or more IR transmitters configured to transmit the one or more decoded commands from the command output to one or more IR receivers of the one or more content sources.

13. The control system of claim 8, further comprising:
a select command device of the one or more command devices;
wherein:
the second unit comprises:
a first content source input configured to couple to a first content source of the content source array;
a second content source input configured to couple to a second content source of the content source array;
a first content path between the first content source input and the second transceiver;
a second content path between the second content source input and the second transceiver; and
a second microcontroller configured to selectively enable the first and second content paths via one or more control signals;
the select command device is affiliated with the first and second units;
the second transceiver is configured to receive from the first unit an encoded select command of the one or more encoded commands,
the encoded select command corresponding to a select command of the one or more commands, the select command sent to the first unit by the select command device;
the encoded select command comprises:
a selection order for the second unit to designate one of the first or second content source inputs for transmission of content to the first unit via the second unit;
and
the second microcontroller is configured to:
enable the first content path and disable the second content path via the one or more control signals when the selection order designates the first content source input; and
enable the second content path and disable the first content path via the one or more control signals when the selection order designates the second content source input.

14. The system of claim 1, wherein:
the first and second transceivers are configured to wirelessly communicate with each other.

15. The system of claim 1, wherein:
the first transceiver is configured to transmit the one or more encoded commands to the second transceiver via RF signals.

16. The system of claim 1, wherein:
the first and second transceivers are configured to communicate with each other via at least one of a cable or a powerline network.

17. The system of claim 1, wherein:
the second unit comprises a content source input array configured to be coupled to the one or more content sources of the content source array;
the first unit comprises an output connector configured to be coupled to a monitor;
the second unit is configured to transmit, via the second transceiver, content from a selected content source of the content source array; and
the first unit is configured to:
receive the content from the second unit via the first and second transceivers; and
feed the content to the output connector for the monitor.

18. The system of claim 17, wherein:
the content source input array comprises a first input to couple with a first content source of the content source array; and
the first input comprises at least one of:
an HDMI video input;
a DVI video input;
a component video input;
a coaxial video input; or
an analog audio input.

19. A control system comprising:
a first unit comprising:
a command input configured to receive one or more original commands from one or more command devices;
a first processing module coupled to the command input and comprising at least one of:
a first signal processor to encode the one or more original commands into one or more encoded commands; or
a first microcontroller to packetize the one or more encoded commands for RF transmission;
a first transceiver coupled to the first processing module to:
transmit the one or more encoded commands via RF command signals; and
receive a content stream via RF content signals;
and
a content output coupled between the first transceiver and a monitor to feed the content stream derived from the RF content signals to the monitor;
and
a second unit comprising:
one or more content source inputs configured to be coupled to one or more content sources and to receive the content stream from the one or more content sources;
a second transceiver configured to:
receive the one or more encoded commands via the RF signals from the first transceiver; and
transmit the content stream to the first transceiver via the RF content signals;
a second processing module coupled to the second transceiver and comprising at least one of:
a second microcontroller to de-packetize the one or more encoded commands packetized by the first microcontroller; or
a second signal processor to decode the one or more encoded commands into one or more decoded commands that mimic the one or more original commands received by the command input of the first unit;
and
a command output coupled to the second processing module to output the one or more decoded commands to the one or more content sources;
wherein the first and second units are separate from each other.

20. The control system of claim 19, wherein:
the second unit further comprises:
a first content path between the second transceiver and a first content source input of the one or more content source inputs; and
a second content path between the second transceiver and a second content source input of the one or more content source inputs;
the command input of the first unit is configured to receive at least one of:
an original functionality command, of the one or more original commands, for controlling a functionality of a first content source of the one or more content sources coupled to the first content source input of the second unit; or
an original select command, of the one or more original commands, for selecting the first content source input out of the one or more content source inputs to source the content stream;
the first signal processor of the first unit is configured to:
encode a command carrier frequency and a command envelope of the original functionality command into an encoded functionality command of the one or more encoded commands;
the second signal processor of the second unit is configured to:
decode the command carrier frequency and the command envelope from the encoded functionality command;
the command output of the second unit is configured to:
reconstruct the original functionality command, as a decoded functionality command of the one or more decoded commands, based on the command carrier frequency and the command envelope decoded by the second signal processor; and
transmit the decoded functionality command to the first content source;
and
the second processing module is configured to:
enable the first content path and disable the second content path when an encoded select command corresponding to the select command is received by the second transceiver as part of the one or more encoded commands.

21. The control system of claim 19, wherein:
the command input of the first unit is configured to receive the one or more original commands via IR input signals; and
the command output of the second unit is configured to output the one or more decoded commands via IR output signals.

22. A method for providing a control system, the method comprising:
providing a first unit to:
receive one or more original commands from one or more command devices;
encode the one or more original commands into one or more encoded commands; and
transmit the one or more encoded commands;
and
providing a second unit to:
receive the one or more encoded commands from the first unit;
reconstruct the one or more original commands as one or more decoded commands based on the one or more encoded commands; and
control with the one or more decoded commands one or more content sources coupled to the second unit;
wherein the first and second units are separate from each other.

23. The method of claim 22, wherein:
providing the second unit comprises providing the second unit to:
receive a content stream from the one or more content sources;
encode the content stream into an encoded content stream; and
transmit the encoded content stream to the first unit;
and
providing the first unit comprises providing the first unit to:
decode the encoded content stream into a decoded content stream; and
provide the decoded content stream to a monitor coupled to the first unit.

24. The method of claim 22, wherein:
providing the first unit further comprises:
providing a first processing module to packetize the one or more encoded commands for RF transmission; and
providing the second unit further comprises:
providing a second processing module to de-packetize the one or more encoded commands when received from the first unit.

25. The method of claim 22, wherein:
providing the first unit comprises:
providing a command input of the first unit to receive the one or more original commands via IR input signals; and
providing the second unit comprises:
providing a command output of the second unit to output the one or more decoded commands via IR output signals.

26. The method of claim 22, wherein:
providing the first unit further comprises:
providing a command input configured to receive the one or more original commands;
providing a first processing module coupled to the command input to encode the one or more original commands into the one or more encoded commands; and
providing a first transceiver coupled to the first processing module and configured to transmit the one or more encoded commands via RF command signals;
and
providing the second unit further comprises:
providing a second transceiver to receive the one or more encoded commands from the first transceiver via the RF command signals;
providing a second processing module coupled to the second transceiver to decode the one or more encoded commands; and
providing a command output configured to output the one or more decoded commands to the one or more content sources, the one or more decoded commands being derived to mimic the one or more original commands based on the one or more encoded commands as decoded by the second processing module.

27. The method of claim 26, wherein:
providing the first unit further comprises:
providing the command input to:
receive an original functionality command of the one or more original commands;
and
providing the first processing module to:
encode a command carrier frequency and a command envelope of the original functionality command into an encoded functionality command of the one or more encoded commands;
and
providing the second unit further comprises:
providing the second signal processor to
decode the command carrier frequency and the command envelope from the encoded functionality command received by the second transceiver as part of the one or more encoded commands;
and
providing the command output to:
reconstruct the original functionality command, as a decoded functionality command of the one or more decoded commands, based on the command carrier frequency and the command envelope decoded by the second signal processor; and
transmit the decoded functionality command to the first content source.

28. The method of claim 26, wherein:
providing the second unit further comprises:
providing one or more content source inputs configured to couple the one or more content sources to the second unit;
providing a first content path between the second transceiver and a first content source input of the one or more content source inputs; and
providing a second content path between the second transceiver and a second content source input of the one or more content source inputs;
providing the first unit further comprises:
providing the command input to receive an original select command, of the one or more original commands, for selecting the first content source input to source a content stream;
and
providing the second unit further comprises:
providing the second processing module to enable the first content path and disable the second content path when an encoded select command corresponding to the original select command is received by the second transceiver as part of the one or more encoded commands.
